(19) United States
(12) Patent Application Publication
(10) Pub. No.: US 2026/0268870 A1
(43) Pub. Date: Sep. 10, 2026

(54) DISPLAY SWITCHING SYSTEM AND SWITCHING METHOD THEREOF

(71) Applicant: Iris Optronics Co., Ltd., Tainan City (TW)

(72) Inventors: Wu Chang YANG, Tainan City (TW); Sheng Yao WANG, Tainan City (TW); Chi Chang LIAO, Tainan City (TW)

(21) Appl. No.: 19/555,903

(22) Filed: Mar. 4, 2026

Related U.S. Application Data
(60) Provisional application No. 63/766,963, filed on Mar. 4, 2025.

(51) Int. Cl. G09G 3/36

(52) U.S. Cl. CPC G09G 3/3629; G09G 2330/023; G09G 2330/027

(57) ABSTRACT

A display device includes a first display and a second display. The second display covers one side of the first display and is configured to switch between a transparent state and a display state according to a switching instruction. The controller is signally connected to the display device, and is configured to perform following steps: obtaining a first image frame and a second image frame, wherein the first image frame and the second image frame are separated by a predetermined number of frames on a time axis; calculating a pixel difference value between the first image frame and the second image frame; and generating the switching instruction according to the pixel difference value to control the second display to switch between the transparent state and the display state.

### RELATED APPLICATIONS

This application claims priority to U.S. Provisional Application Serial Number 63/766,963, filed Mar. 4, 2025, which is herein incorporated by reference.

### BACKGROUND

### Technical Field

The present disclosure relates to a display switching system and a display switching method.

### Description of Related Art

Modern life is inseparable from 3C products, and prolonged use of 3C products may cause eye damage and visual impairment. Common 3C products employ self-emissive displays, such as Liquid Crystal Display (LCD), Organic Light-Emitting Diode (OLED), or Light-Emitting Diode (LED).

Although self-emissive displays perform well for dynamic images, they include a light-emitting source, and the brightness and blue light of the source may harm the eyes. In addition, continuous energy consumption is required to maintain the light emission for display.

Cholesteric Liquid Crystal Display (ChLCD) do not require an active light source and only rely on ambient light reflection. They impose less visual strain and can maintain static images without energy consumption due to their memory effect. However, ChLCD perform poorly for dynamic images.

Therefore, the current market lacks a display switching system and display switching method capable of switching between a self-emissive display and a reflective display, and relevant industries are seeking solutions to this problem.

### SUMMARY

The present disclosure provides a display switching system, includes a display device and a controller. The display device includes a first display and a second display. The second display covers one side of the first display and is configured to switch between a transparent state and a display state according to a switching instruction. The controller is signally connected to the display device, and is configured to perform the following steps: obtaining a first image frame and a second image frame, wherein the first image frame and the second image frame are separated by a predetermined number of frames on a time axis; calculating a pixel difference value between the first image frame and the second image frame; and generating the switching instruction according to the pixel difference value to control the second display to switch between the transparent state and the display state. When the pixel difference value is greater than or equal to a difference threshold, the controller drives the second display to be in the transparent state. When the pixel difference value is less than the difference threshold, the controller drives the second display to be in the display state.

The present disclosure provides a display switching method. The display switching method is configured to control a display device to switch, the display device includes a first display and a second display, the second display covering one side of the first display. The display switching method includes: obtaining a first image frame and a second image frame by a controller, wherein the first image frame and the second image frame are separated by a predetermined number of frames on a time axis; calculating a pixel difference value between the first image frame and the second image frame by the controller; and generating a switching instruction according to the pixel difference value by the controller, to control the second display to switch between a transparent state and a display state. When the pixel difference value is greater than or equal to a difference threshold, the controller drives the second display to be in the transparent state. When the pixel difference value is less than the difference threshold, the controller drives the second display to be in the display state.

### BRIEF DESCRIPTION OF THE DRAWINGS

The present disclosure can be more fully understood by reading the following detailed description of the embodiment, with reference made to the accompanying drawings as follows:

FIG. 1 is a block diagram illustrating a display switching system according to a 1st embodiment of the present disclosure;

FIG. 2 is a schematic diagram illustrating the display device shown in FIG. 1;

FIG. 3 is a schematic diagram illustrating a target region according to the 1st embodiment of the present disclosure;

FIG. 4 is a schematic diagram illustrating a target region according to a 2nd embodiment of the present disclosure;

FIG. 5 is a schematic diagram illustrating a target region according to a 3rd embodiment of the present disclosure;

FIG. 6 is a schematic diagram illustrating a target region according to a 4th embodiment of the present disclosure; and

FIG. 7 is a flowchart illustrating a display switching method according to a 5th embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

In addition, when an element (or unit, module, etc.) is “connected” to another element, it may mean that the element is directly connected to the other element, or indirectly connected to the other element; that is, other elements may be interposed between said element and the other element. An absence of intervening elements between elements is only indicated when it is explicitly stated that an element is “directly connected” to another. The terms such as “first,” “second,” and “third” are used herein to describe various elements and should not be limited by these terms. Thus, a first element could also be referred to as a second element. Furthermore, the combinations of elements, units and circuits herein are not general, routine, or conventional combinations in the field. The ease of completion by a person of ordinary skill in the art should not be determined based on whether the elements, units and circuits themselves are conventional.

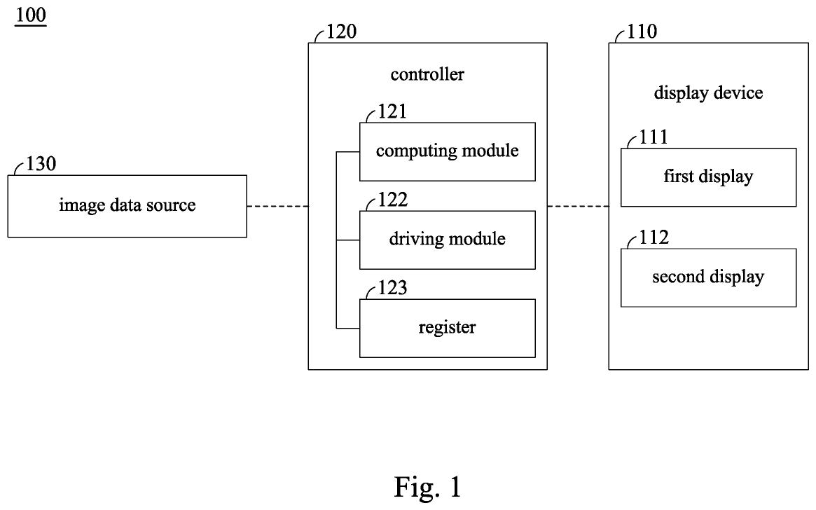

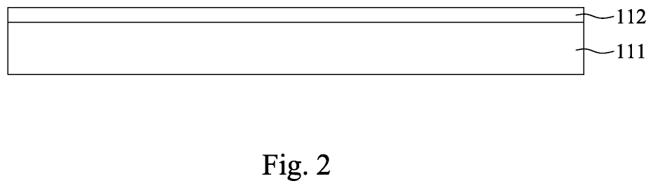

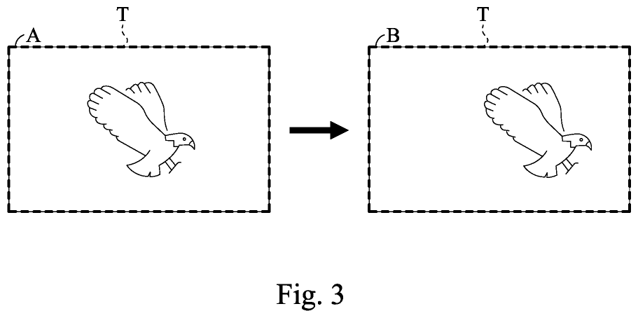

Please refer to FIG. 1, FIG. 2 and FIG. 3. FIG. 1 is a block diagram illustrating a display switching system according to a 1st embodiment of the present disclosure. FIG. 2 is a schematic diagram illustrating the display device shown in FIG. 1. FIG. 3 is a schematic diagram illustrating a target region according to the 1st embodiment of the present disclosure. The display switching system 100 includes the display device 110 and a controller 120, wherein the controller 120 is signally connected to the display device 110. In addition, the display switching system 100 further includes an image data source 130, the image data source 130 is signally connected to the controller 120.

The display device 110 is configured to display an image data. The display device 110 includes a first display 111 and a second display 112, the second display 112 covers one side of the first display 111 (as shown in FIG. 2). From a viewing direction of a user, the second display 112 is disposed in front, and the first display 111 is disposed behind. The controller 120 is configured to drive the first display 111 and the second display 112 according to the image data, and to control the second display 112 to switch between a transparent state and a display state according to a first image frame A and a second image frame B (as shown in FIG. 3). The image data source 130 is configured to output the image data to the controller 120.

The image data includes a plurality of image frames, and the first image frame A and the second image frame B are selected from the plurality of image frames. The first image frame A and the second image frame B are separated by a predetermined number of frames on a time axis. For example, assuming that the first image frame A is an n-th frame of the image frames and the predetermined number of frames is m, the second image frame B is an (n+m)-th frame of the image frames, wherein n and m are integers greater than or equal to 1.

In the 1st embodiment, the first display 111 may be a self-emissive display, such as an LCD, an OLED, or an LED; the second display 112 may be a reflective display, such as a ChLCD; and the controller 120 may be a microprocessor, a system-on-chip (SoC), a central processing unit (CPU), a mobile device processor, a cloud processor, or other electronic processing devices, but the present disclosure is not limited thereto.

The second display 112 is configured to switch between the transparent state and the display state according to a switching instruction. In the 1st embodiment, the transparent state of the second display 112 corresponds to a Homeotropic State of a ChLCD, and the display state corresponds to a Planar State of the ChLCD.

The controller 120 obtains the first image frame A and the second image frame B, and calculates a pixel difference value between the first image frame A and the second image frame B. Finally, the controller 120 generates the switching instruction according to the pixel difference value to control the second display 112 to switch between the transparent state and the display state.

When the pixel difference value is greater than or equal to a difference threshold, the controller 120 drives the second display 112 to be in the transparent state; when the pixel difference value is less than the difference threshold, the controller 120 drives the second display 112 to be in the display state. In addition, when the second display 112 is in the transparent state according to the switching instruction, the controller 120 simultaneously drives the first display 111 to perform display. When the second display 112 is in the display state according to the switching instruction, the controller 120 simultaneously stops driving the first display 111.

Specifically, the controller 120 monitors a frequency of changes in the image data by comparing the pixel difference value with the difference threshold, and determines whether the image data is to be displayed by the first display 111 or the second display 112 accordingly, thereby generating the switching instruction to switch an operating mode of the second display 112.

When the pixel difference value is greater than or equal to the difference threshold, it indicates that the image data is changing frequently and the display device 110 is in a dynamic usage state. In this case, the controller 120 switches the second display 112 to the transparent state, and the image data is displayed by the first display 111 located behind the second display 112. When the pixel difference value is less than the difference threshold, it indicates that the image data has little or no change and the display device 110 is in a static usage state. In this case, the controller 120 switches the second display 112 to the display state, and the image data is displayed by the second display 112, while the controller 120 stops driving the first display 111 (i.e., the first display 111 is turned off).

Further, when the display device 110 is in the dynamic usage state, the user may be viewing dynamic images. The controller 120 switches the second display 112 to the transparent state and drives the first display 111, which is a self-emissive display disposed behind the second display 112, to perform display, thereby ensuring smoothness and color vividness of the image data. When the display device 110 is in the static usage state, the user may be viewing the same image or may not be actively using the display device 110. The controller 120 switches the second display 112 to the display state, and the image data is displayed by the second display 112, which is a ChLCD, while stopping driving the first display 111, thereby achieving power saving and reduced eye strain.

Accordingly, by utilizing the pixel difference value between the first image frame A and the second image frame B, a frequency of changes in the image data can be monitored, thereby enabling automatic and seamless switching between a high-quality dynamic display mode and a low-power static eye-friendly display mode. Thus, a smooth visual experience is ensured while significantly reducing energy consumption and improving comfort during prolonged viewing of the display device 110.

Further, the controller 120 includes a computing module 121, a driving module 122 and a register 123, which are coupled to each other. The computing module 121 is configured to calculate the pixel difference value. The driving module 122 is configured to compare the pixel difference value with the difference threshold to generate the switching instruction, so as to drive the second display 112 to switch between the transparent state and the display state, and to selectively drive the first display 111 according to the switching instruction. The register 123 is configured to temporarily store the first image frame A and the second image frame B.

Specifically, the computing module 121 obtains the first image frame A and the second image frame B from the register 123, and compares pixel variations corresponding to a target region T in the first image frame A and the second image frame B to obtain the pixel difference value. A number of pixels that change within the target region T is defined as the pixel difference value. Subsequently, the driving module 122 compares the pixel difference value with the difference threshold, and determines whether the current image data is in the dynamic usage state or the static usage state accordingly, thereby generating the switching instruction to switch an operating mode of the second display 112. In the 1st embodiment, the target region T is an entire image region of the first image frame A and the second image frame B, but the present disclosure is not limited thereto.

Furthermore, it should be noted that, the computing module 121 periodically obtains the first image frame A and the second image frame B from the register 123 and calculates the pixel difference value, so that the driving module 122 can control the second display 112 to switch between the transparent state and the display state in real time.

Further referring to the embodiment shown in FIG. 3, the target region T is the entire image region of the first image frame A and the second image frame B, and the difference threshold is assumed to be 100. As shown in FIG. 3, an eagle pattern in the second image frame B is displaced relative to the eagle pattern in the first image frame A. The computing module 121 calculates the pixel difference value by comparing pixel variations over the entire image region of the first image frame A and the second image frame B, and obtains a pixel difference value of 150 (i.e., the number of changed pixels in the entire image region is 150). After comparing the pixel difference value with the difference threshold, the driving module 122 confirms that the pixel difference value is greater than the difference threshold and determines that the current image data is in the dynamic usage state. Accordingly, the driving module 122 drives the second display 112 to be in the transparent state, and drives the first display 111 disposed behind the second display 112 to perform display.

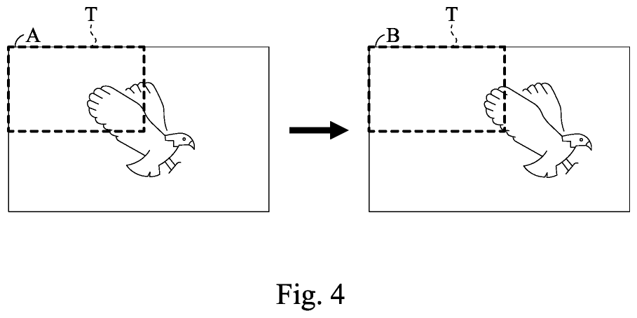

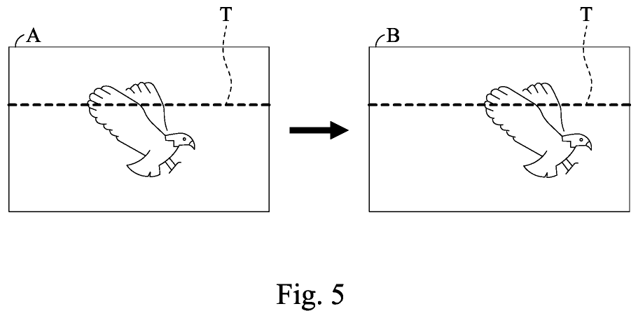

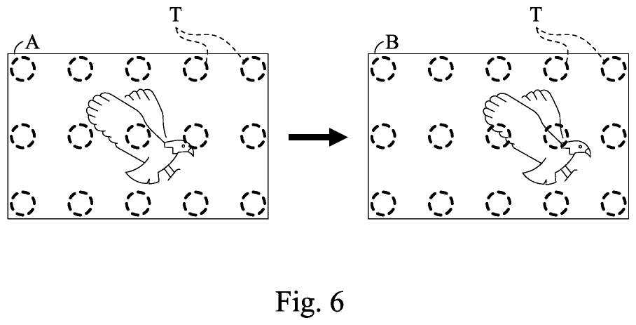

Please refer to FIG. 1, FIG. 4, FIG. 5 and FIG. 6. FIG. 4 is a schematic diagram illustrating a target region according to a 2nd embodiment of the present disclosure. FIG. 5 is a schematic diagram illustrating a target region according to a 3rd embodiment of the present disclosure. FIG. 6 is a schematic diagram illustrating a target region according to a 4th embodiment of the present disclosure. The target region T may be a partial region of the first image frame A and the second image frame B to reduce a computational burden of the computing module 121 of the controller 120 so as to improve processing efficiency.

As shown in FIG. 4, in the 2nd embodiment, the target region T may be a rectangular image region in each of the first image frame A and the second image frame B. The computing module 121 calculates the pixel difference value by comparing pixel variations within the rectangular image region.

As shown in FIG. 5, in the 3rd embodiment, the target region T may be a row (line) of pixels in each of the first image frame A and the second image frame B. The computing module 121 calculates the pixel difference value by comparing pixel variations of the row of pixels.

As shown in FIG. 6, in the 4th embodiment, the target region T may be a plurality of random image blocks in each of the first image frame A and the second image frame B. The computing module 121 calculates the pixel difference value by comparing pixel variations within the random image blocks.

In addition, in the embodiments shown in FIG. 4, FIG. 5 and FIG. 6, the difference threshold may be set or adjusted according to requirements of the respective embodiments or a degree of variation of the pixel difference value.

Further, when the display device 110 is in a non-powered state, the second display 112 continues to display a standby screen. The standby screen is either a preset image or a last image frame of the display device 110 before entering the non-powered state.

Specifically, when the controller 120 receives a power-off signal, the display device 110 enters a shutdown procedure (that is, the display device 110 is in a non-powered state) while the second display 112 displays the standby screen. Because the second display 112 is ChLCD, it can stably maintain the standby screen without consuming power.

Accordingly, after the display device 110 is powered off, the second display 112 can maintain display of the preset image as a digital photo frame, integrating with home or office environments, or maintain display of last image frame, providing an information-recording function.

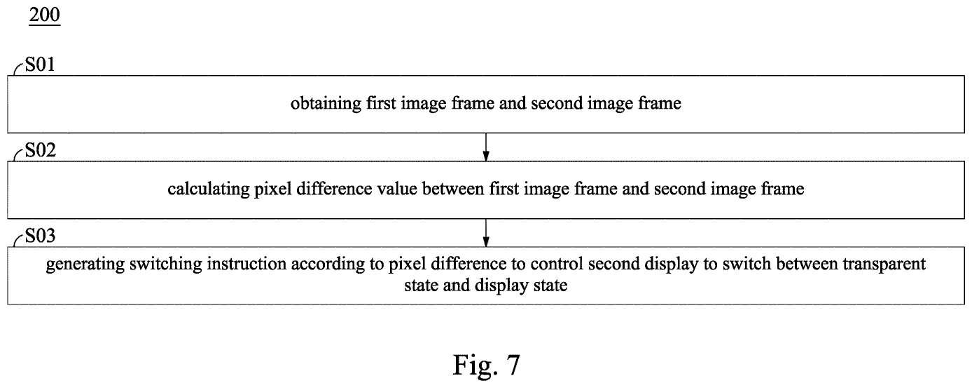

Please refer to FIG. 1 to FIG. 3 and FIG. 7. FIG. 7 is a flowchart illustrating a display switching method according to a 5th embodiment of the present disclosure. The display switching system 100 is configured to implement the display switching method 200. It should be noted that the display switching method 200 of the present disclosure is not limited to being implemented through the display switching system 100 disclosed herein. The display device 110 includes the first display 111 and the second display 112 covering one side of the first display 111. The display switching method 200 is configured to monitor a frequency of changes in the image data and to control the second display 112 to switch between the transparent state and the display state. The display switching method 200 includes step S01, step S02, and step S03.

In step S01, the controller 120 obtains the first image frame A and the second image frame B. The first image frame A and the second image frame B are selected from the image data output by the image data source 130, which includes a plurality of image frames. The first image frame A and the second image frame B are separated by the predetermined number of frames on the time axis.

In step S02, the controller 120 calculates a pixel difference value between the first image frame A and the second image frame B. Specifically, the controller 120 compares the pixel variations corresponding to the target region T of the first image frame A and the second image frame B to obtain the pixel difference value. The number of changed pixels within the target region T is defined as the pixel difference value. In the 5th embodiment, the target region T may be the entire image region, the rectangular image region, the row of pixels, or the plurality of random image blocks of the first image frame A and the second image frame B, but the present disclosure is not limited thereto.

In step S03, the controller 120 generates the switching instruction according to the pixel difference value to control the second display 112 to switch between the transparent state and the display state. By comparing the pixel difference value with the difference threshold, the controller 120 monitors the frequency of changes in the image data, determines whether the first display 111 or the second display 112 should display the image data, and generates the switching instruction to switch the mode of the second display 112.

When the pixel difference value is greater than or equal to the difference threshold, the controller 120 drives the second display 112 to the transparent state. When the pixel difference value is less than the difference threshold, the controller 120 drives the second display 112 to the display state. In addition, when the second display 112 is in the transparent state according to the switching instruction, the controller 120 simultaneously drives the first display 111 to perform display. When the second display 112 is in the display state, the controller 120 simultaneously stops driving the first display 111.

Accordingly, by utilizing the pixel difference value between the first image frame A and the second image frame B, the frequency of changes in the image data can be monitored, enabling automatic and seamless switching between a high-quality dynamic display mode and a low-power static eye-friendly display mode, which combines the advantages of reflective displays and self-emissive displays, ensuring smooth visual experience while significantly reducing energy consumption and improving comfort for prolonged viewing of the display device 110.

Furthermore, it should be noted that, step S01 is executed periodically, obtaining different first image frame A and second image frame B at set intervals, followed by step S02 to calculate the pixel difference value, allowing the controller 120 to real-time control the second display 112 to switch between the transparent state and the display state according to usage of the display device 110.

From the above embodiments, the present disclosure provides the following advantages: First, by periodically determining the pixel difference value between the first image frame and the second image frame, the frequency of changes in the image data can be monitored, enabling automatic and seamless switching between high-quality dynamic display and low-power static eye-friendly display. This combines the advantages of reflective displays and self-emissive displays, ensuring smooth visual experience while significantly reducing energy consumption and improving comfort during prolonged viewing of the display device. Second, after power is cut off, the display device can maintain display of a preset image via the second display as a digital photo frame, integrating with home or office environments, or maintain display of last image frame, providing an information-recording function.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display switching system, comprising:
a display device, comprising:
a first display; and
a second display covering one side of the first display and configured to switch between a transparent state and a display state according to a switching instruction; and
a controller signally connected to the display device, and configured to perform following steps:
obtaining a first image frame and a second image frame, wherein the first image frame and the second image frame are separated by a predetermined number of frames on a time axis;
calculating a pixel difference value between the first image frame and the second image frame; and
generating the switching instruction according to the pixel difference value to control the second display to switch between the transparent state and the display state;
wherein, when the pixel difference value is greater than or equal to a difference threshold, the controller drives the second display to be in the transparent state; and
when the pixel difference value is less than the difference threshold, the controller drives the second display to be in the display state.

2. The display switching system of claim 1, wherein,
when the second display is in the transparent state according to the switching instruction, the controller drives the first display to perform display; and
when the second display is in the display state according to the switching instruction, the controller stops driving the first display.

3. The display switching system of claim 1, wherein the controller comprises:
a computing module configured to calculate the pixel difference value;
a driving module configured to compare the pixel difference value with the difference threshold to generate the switching instruction, so as to drive the second display to switch between the transparent state and the display state, and selectively drive the first display according to the switching instruction; and
a register configured to temporarily store the first image frame and the second image frame.

4. The display switching system of claim 3, wherein the computing module compares pixel variations corresponding to a target region in the first image frame and the second image frame to obtain the pixel difference value.

5. The display switching system of claim 4, wherein the target region is an entire image region of each of the first image frame and the second image frame.

6. The display switching system of claim 4, wherein the target region is a rectangular image region in each of the first image frame and the second image frame.

7. The display switching system of claim 4, wherein the target region is a row of pixels in each of the first image frame and the second image frame.

8. The display switching system of claim 4, wherein the target region is a plurality of random image blocks in each of the first image frame and the second image frame.

9. The display switching system of claim 1, wherein the first display is a self-emissive display, and the second display is a reflective display.

10. The display switching system of claim 1, further comprising:
an image data source signally connected to the controller and configured to output an image data, the image data comprising a plurality of image frames;
wherein, the first image frame and the second image frame are selected from the plurality of image frames.

11. The display switching system of claim 1, wherein,
when the display device is in a non-powered state, the second display continues to display a standby screen, wherein the standby screen is a preset image or a last image frame displayed by the display device before entering the non-powered state.

12. A display switching method, configured to control a display device to switch, the display device comprising a first display and a second display, the second display covering one side of the first display, the display switching method comprising:
obtaining a first image frame and a second image frame by a controller, wherein the first image frame and the second image frame are separated by a predetermined number of frames on a time axis;
calculating a pixel difference value between the first image frame and the second image frame by the controller; and
generating a switching instruction according to the pixel difference value by the controller, to control the second display to switch between a transparent state and a display state;
wherein, when the pixel difference value is greater than or equal to a difference threshold, the controller drives the second display to be in the transparent state; and
when the pixel difference value is less than the difference threshold, the controller drives the second display to be in the display state.

13. The display switching method of claim 12, wherein,
when the second display is in the transparent state according to the switching instruction, the controller drives the first display to perform display; and
when the second display is in the display state according to the switching instruction, the controller stops driving the first display.

14. The display switching method of claim 12, wherein the controller compares pixel variations corresponding a target region in the first image frame and the second image frame to obtain the pixel difference value.

15. The display switching method of claim 14, wherein the target region is an entire image region of each of the first image frame and the second image frame.

16. The display switching method of claim 14, wherein the target region is a rectangular image region in each of the first image frame and the second image frame.

17. The display switching method of claim 14, wherein the target region is a row of pixels in each of the first image frame and the second image frame.

18. The display switching method of claim 14, wherein the target region is a plurality of random image blocks in each of the first image frame and the second image frame.
